(19) United States
(12) Patent Application Publication
(10) Pub. No.: US 2009/0051766 A1
(43) Pub. Date: Feb. 26, 2009

(54) Monitoring System and Imaging Device

(76) Inventors: Mitsuhiro Shimbo, Yokohama (JP); Yoshifumi Fujikawa, Yokohama (JP); Hideki Sakao, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/185,839

(22) Filed: Aug. 5, 2008

(30) Foreign Application Priority Data
Aug. 9, 2007 (JP) 2007-208186

(51) Int. Cl. H04N 7/18

(52) U.S. Cl. 348/143; 348/E07.085

(57) ABSTRACT

An imaging device has a frame selector that performs frame removal processing for removing certain image frames from the image data such that groups of successive image frames remain at predetermined intervals. A monitoring center has a high resolution processor that uses received multiple image frames to perform high resolution processing. The frame selector has a motionless frame generator for generating motionless image frames indicating no motion compared with an image frame to be referenced. The frame selector inserts the motionless image frames into positions in the image data at which image frames have been removed by the frame removal processing to form image data to be transmitted. It is therefore possible to reduce the amount of data to be transmitted and display an acquired image at a high resolution.

### CLAIM OF PRIORITY

The present application claims priority from Japanese Patent Application JP 2007-208186 filed on Aug. 9, 2007, the content of which is hereby incorporated by reference into this application.

### BACKGROUND OF THE INVENTION

The present invention relates to a monitoring system for transmitting image data acquired by an imaging device to a monitoring center and displaying an image, and more particularly to a technique for displaying an image at high resolution while suppressing the amount of data to be transmitted.

A conventional monitoring system uses an encoding technique such as MPEG to compress an image acquired by a camera installed in a place to be monitored, transmits the compressed data to a center, displays the image, and detects an abnormality of the monitored place. When the camera used to monitor the place complies with a normal television standard, the camera has a maximum resolution of 640×480 pixels at most. In this case, it may be difficult to recognize an imaged subject in detail. Although a high-resolution camera may be conceivably used to improve the quality and resolution of monitoring images, the cost of the camera increases, and the amount of data to be transmitted also increases. Therefore, the high-resolution camera is not suitable for practical use.

Such being the case, to perform high resolution processing on an acquired image and suppress an increase in the amount of data to be transmitted, the following techniques have been disclosed.

JP-A-08-336046 discloses a technique for converting a plurality of input digital images into a single high-resolution image having a resolution higher than those of the input digital images (hereinafter referred to as super resolution processing). This technique is to sample an N pair of data pieces from a signal by performing the sampling an N number of times at the same sampling intervals at different sampling positions, cancel alias components generated by the sampling, and thereby restore high frequency components (higher than the Nyquist frequency) of the original signal.

JP-A-2005-150808 discloses a monitoring image recording system that utilizes super resolution processing. The system compresses image data acquired by a camera and performs the super resolution processing on the image data by using frame data, motion vectors, and macroblocks that are generated during the compression in order to generate high-resolution image data. The system then transmits the generated high-resolution image data to a storage device, where the data is stored.

JP-A-2002-125226 discloses a frame rate control method for receiving image frames in real time, performing conversion on the received image frames, processing the converted image frames, and transmitting the processed image frames. In the method, when an upper limit of frame transmission rate is specified, the number of transmitted frames is reduced for a certain period of time after the start of the transmission of the frames. Since the number of the frames is reduced, the frame transmission rate is controlled so that it does not exceed the upper limit.

### SUMMARY OF THE INVENTION

In a conventional monitoring system, it is not easy to suppress the amount of data to be transmitted while generating a high-resolution image to be displayed. For example, when the high-resolution processing disclosed in JP-A-08-336046, etc. is employed, the amount of data on a generated high-resolution image inevitably increases. In addition, successive image frames are required for the processing.

Also, in the monitoring image recording system disclosed in JP-A-2005-150808, when generated high-resolution images are transmitted to a storage device without frame removal, the amount of data increases and may exceed an allowable range.

On the other hand, a method as disclosed in JP-A-2002-125226 may be conceivably employed, in which frames are removed to reduce the amount of transmission data, and high resolution processing is then performed on the data receiving side.

However, the high resolution processing requires a plurality of prior and posterior frames for an image to be processed. Therefore, a high-resolution image cannot be generated by simple frame removal processing.

It is, therefore, an object of the present invention to provide a monitoring system capable of performing high-resolution processing while suppressing the amount of data to be transmitted and an imaging device to be used for the monitoring system.

In one aspect, the present invention is a monitoring system that transmits image data acquired by an imaging device to a monitoring center through a transmitter and displays an image. The imaging device has a frame selector for removing certain image frames from the image data such that groups of successive image frames remain at predetermined intervals. The monitoring center has a high resolution processor for performing high resolution processing with the use of received image frames.

The frame selector has a motionless frame generator for generating motionless image frames indicating no motion compared with an image frame to be referenced. The frame selector inserts the motionless frames into positions in the image data at which image frames have been removed by the frame removal processing to form image data to be transmitted.

The imaging device has a first switch controller for controlling the frame removal processing to be performed by the frame selector. The monitoring center has a second switch controller for controlling the high resolution processing to be performed by the high resolution processor. The first and second switch controllers inform each other of their own processing conditions through the transmitter.

In another aspect, the present invention is an imaging device that acquires image data and transmits the acquired image data to a monitoring center. The imaging device has a frame selector that performs frame removal processing for removing certain image frames from the image data such that groups of successive image frames remain at predetermined intervals. The imaging device transmits the image data subjected to the frame removal processing at the frame selector.

According to the present invention, it is possible to realize a monitoring system capable of displaying an acquired image at a high resolution while suppressing the amount of data to be transmitted.

### BRIEF DESCRIPTION OF THE DRAWINGS

FIG. 1 is a diagram showing the configuration of a monitoring system according to a first embodiment of the present invention.

FIG. 2 is a diagram showing an example of the configuration of a frame selector 12.

FIGS. 3A to 3C are diagrams showing examples of image frames generated by the frame selector 12.

FIGS. 4A to 4C are diagrams showing high resolution processing to be performed by a high resolution processor 31.

FIG. 5 is a diagram showing another example of the configuration of the frame selector 12.

FIGS. 6A to 6C are diagrams showing examples of image frames generated by the frame selector 12 shown in FIG. 5.

FIG. 7 is a diagram showing a monitoring system according to a third embodiment of the present invention.

### DESCRIPTION OF THE PREFERRED EMBODIMENTS

Embodiments of the present invention will be described below with reference to the accompanying drawings.

### First Embodiment

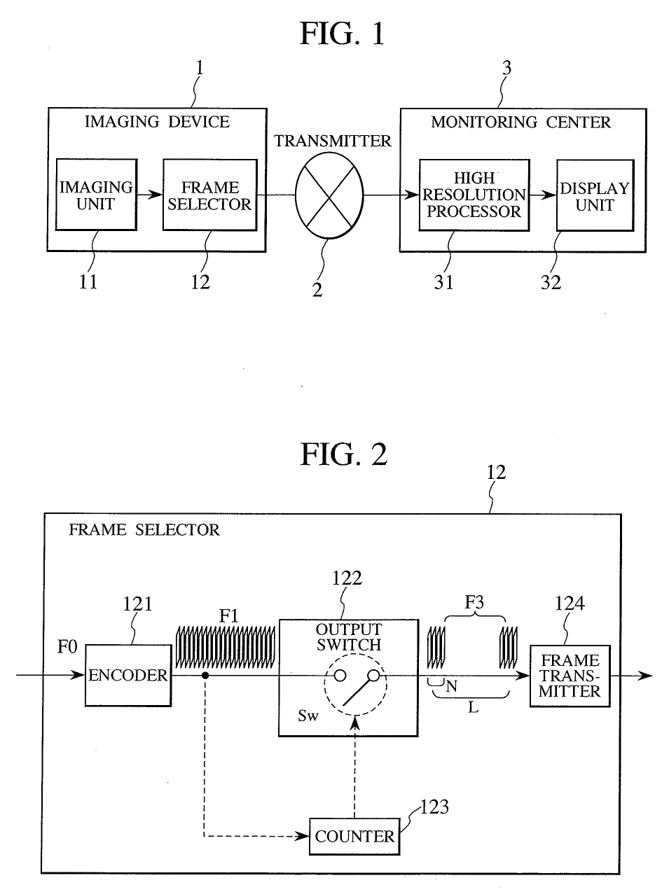

FIG. 1 is a diagram showing a monitoring system according to a first embodiment of the present invention.

The monitoring system includes an imaging device 1, a transmitter 2, and a monitoring center 3. The imaging device 1 acquires an image indicating an area monitored. The monitoring system transmits the acquired image to the monitoring center 3 via the transmitter 2 in order to detect an abnormality of the area monitored. The monitoring center 3 may also be designed to monitor a plurality of the imaging devices 1.

The imaging device 1 has an imaging unit (camera) 11 and a frame selector 12. The imaging unit 11 is composed of a lens and an imaging element and photographs a subject. The frame selector 12 compresses the acquired image by encoding, removes at least one image frame from the compressed image, and transmits its image data to the monitoring center 3. The transmitter 2 uses a local area network (LAN) or an Internet connection. The monitoring center 3 is equipped with a high resolution processor 31 and a display unit 32. The high resolution processor 31 decodes the received image data and performs high resolution processing on the image data. The display unit 32 displays an image included in the image data subjected to the high resolution processing.

The monitoring system according to the present embodiment is capable of reducing the amount of image data to be transmitted from the imaging device 1 to the monitoring center 3 and of performing high resolution processing on the image data at the monitoring center 3. Specifically, the imaging device 1, the data transmitting side, removes at least one image frame and transmits data excluding the removed image frame. This reduces the amount of data transmitted to the transmitter 2 and reduces a load on the transmitter 2. In other words, a larger number of the imaging devices 1 can be connected to the transmitter 2 as long as the amount of data transmitted is in an allowable range of the transmission capability of the transmitter 2. In frame removal processing for removing at least one image frame from the image data, the frame selector 12 selects and transmits image frames required for the high resolution processing. Therefore, the monitoring center 3, the data receiving side, can normally perform the high resolution processing on the image frames to generate a high-resolution image and can display the high-resolution image.

FIG. 2 is a diagram showing an example of the configuration of the frame selector 12.

An encoder 121 uses an encoding scheme such as MPEG-2 to encode an image signal F0 transmitted by the imaging unit 11. The encoder 121 then generates a successive image-frame sequence F1. An output switch 122 is an ON/OFF switch. The output switch 122 performs frame removal processing for removing at least one image frame from the successive image-frame sequence F1 to generate an intermittent image-frame sequence F3. A frame transmitter 124 transmits the generated intermittent image-frame sequence F3 to the transmitter 2.

A counter 123 counts the number of frames in the image-frame sequence F1 to be input and transmits to the output switch 122 a switch control signal for removing at least one image frame from the image-frame sequence F1. The output switch 122 selects a predetermined N number of successive image-frame sequences from the successive image-frame sequence F1 at predetermined intervals L in accordance with the switch control signal to generate an intermittent image-frame sequence. In this case, the N number is a plural number required for the high resolution processing to be performed by the high-resolution processor 31.

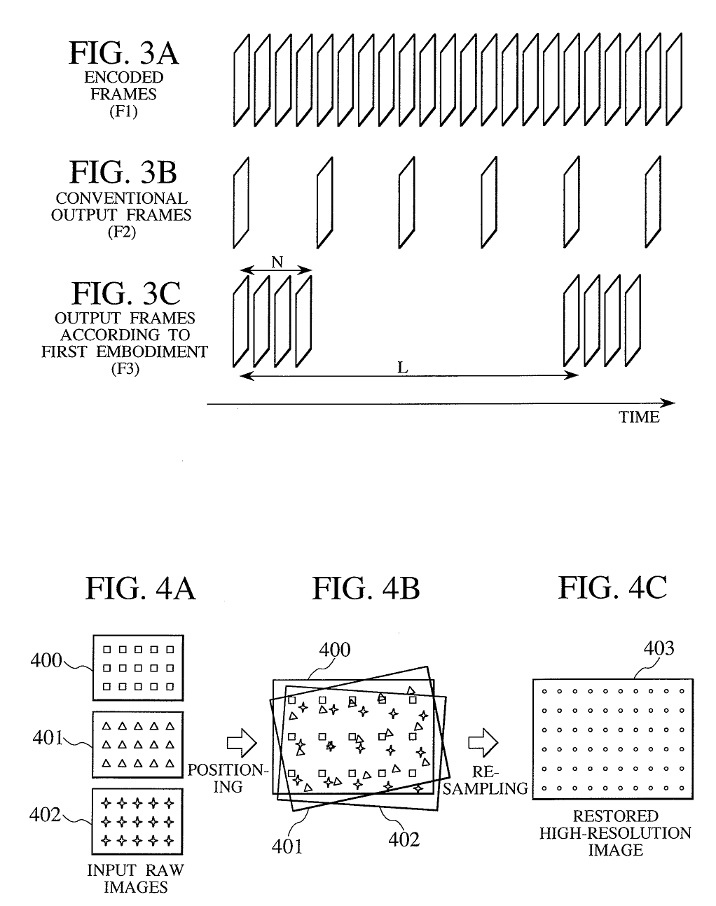

FIGS. 3A to 3C are diagrams showing examples of image frames generated by the frame selector 12. FIG. 3A shows the encoded image-frame sequence F1. FIG. 3B shows an image-frame sequence F2 output by a conventional technique for comparison with the present embodiment. FIG. 3C shows the output image-frame sequence F3 according to the present embodiment.

As in FIG. 3B, the frame sequence F2 has been conventionally used for data amount reduction, in which a certain number of frames are removed from the frame sequence at predetermined intervals, and the remaining frames are isolated from each other as a single frame. In this case, the amount of image motion between the frames becomes large in the frame sequence F2. Accordingly, high resolution processing on the data receiving side can be expected to be difficult. That is, when image frames having large amounts of motion are combined, the quality of the images may be compromised.

In contrast, the present embodiment uses the intermittent frame sequence F3, shown in FIG. 3C, in which frames are removed from the frame sequence so as to leave a predetermined N number of successive frames at predetermined intervals L. In the example shown in FIG. 3C, the predetermined N number is 4, and the predetermined intervals L are 16. In this case, the amount of image motion between frames is small in the N number of successive frames. Therefore, the monitoring center 3, the data receiving side, can normally perform the high resolution processing, using those successive frames. In addition, since image frames are removed from an input frame sequence, the number of the image frames is reduced. This results in a reduction in the amount of data transmitted.

According to the present embodiment, it is thus possible to realize the high resolution processing while reducing the amount of data transmitted.

FIGS. 4A to 4C are diagrams showing the high resolution processing to be performed by the high resolution processor 31. As typical high resolution processing, the super resolution processing disclosed in JP-A-H08-336046 will be described below. As shown in FIG. 4A, a plurality of raw successive images 400 to 402 (three raw images in this case) are prepared. The raw images 400 to 402 are positioned with fractional pixel accuracy. FIG. 4B shows the state in which the image 400 is used as a positional standard, and the images 401 and 402 are positioned based on the standard. The positioning is performed allowing for motions such as rotation and scaling up and down. In this way, a composite image, in which sampling positions are shifted from integer pixel positions, is generated. After that, re-sampling is performed at an intended sampling rate to generate a high-resolution image 403, as shown in FIG. 4C. In the re-sampling, a pixel value is determined by performing convolution of adjacent pixels through a method in which a low pass filter is used to interpolate pixels (sampling points), through a method in which a function inverse to a point-spread function is used, or through other similar methods. As a result, high frequency components of the raw images can be restored. In addition, a high-resolution image, in which blurs are minimized, can be generated.

The high resolution processor 31 according to the present invention is not limited to the super resolution processing described in JP-A-H08-336046. Any high resolution processor that processes successive images with a motion is applicable to the present embodiment.

### Second Embodiment

Next, a second embodiment of the present invention will be described. In the second embodiment, image frames are transmitted after modified.

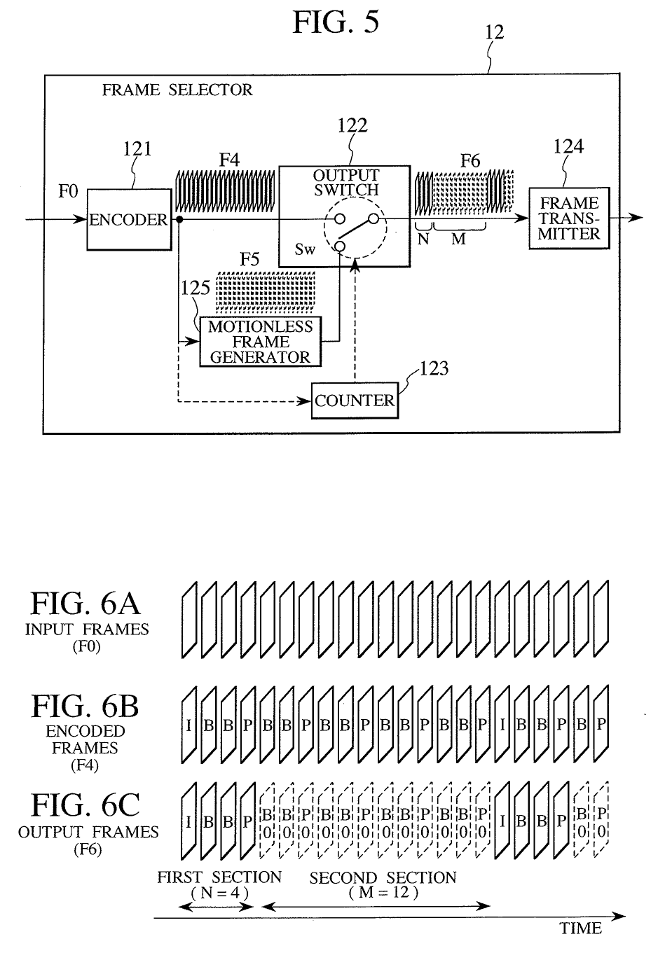

FIG. 5 is a diagram showing another configuration of the frame selector 12. The frame selector 12 shown in FIG. 5 is configured by adding a motionless frame generator 125 to the frame selector shown in FIG. 2.

The encoder 121 uses an encoding scheme such as MPEG-2 to encode an image signal F0 transmitted by the imaging unit 11. The encoder 121 then generates a successive image-frame sequence F4. In synchronization with the image-frame sequence F4, the motionless frame generator 125 generates an image-frame sequence F5 that indicates no motion (zero difference) compared with an image frame to be referenced. In the MPEG-2 encoding scheme, when there is no motion, the data amount of frames shows the minimum.

The output switch 122 selects either the image-frame sequence F4 transmitted from the encoder 121 or the image-frame sequence F5 transmitted from the motionless frame generator 125 to generate an image-frame sequence F6 to be transmitted. Specifically, the image-frame sequence F6 are combined by inserting the motionless image-frame sequence F5 into frame positions of the image-frame sequence F4 at which some frames are removed for data size reduction. The frame transmitter 124 transmits the combined image-frame sequence F6 to the transmitter 2.

In this case, the counter 123 counts the number of frames in the input image-frame sequence F4 and transmits to the output switch 122 a switch control signal to be used for frame selection. The switch control signal is used to alternately select an N number of successive image frames from the image-frame sequence F4 and an M number of successive image frames from the image-frame sequence F5. In the frame selection, the frame selector 12 identifies the types of image frame (distinguishes among types I, P and B), as described later. The frame selector 12 performs control to put an I frame in the N number of successive image frames selected from the image-frame sequence F4. The high resolution processor 31 performs the high resolution processing using the N number of successive image frames including the I frame.

FIGS. 6A to 6C are diagrams showing examples of image frames generated by the frame selector 12 shown in FIG. 5. FIG. 6A shows the raw-image-frame sequence F0 input to the encoder 121. FIG. 6B shows the image-frame sequence F4 encoded by MPEG-2. FIG. 6C shows the output image-frame sequence F6 according to the present embodiment.

In FIGS. 6B and 6C, the symbols “I,” “P,” and “B” indicate an I frame, a P frame, and a B frame, respectively. The I frame can be decoded independently of the others. The P frame can be decoded by referring to either a prior I frame or a prior P frame in time sequence. The B frame can be decoded by referring to both of prior and posterior I frames or both of prior and posterior P frames in time sequence. The symbols P0 and B0 indicate motionless frames.

In the encoded image-frame sequence F4 of FIG. 6B, the frame selector 12 selects, as frames subjected to the high resolution processing, four (N=4) successive image frames (first section) including an I frame that is the first frame of the first section, and the frame selector 12 then removes twelve (M=12) image frames (second section) that follows the first section. After that, the frame selector 12 inserts the motionless-image-frame sequence F5 (P0 and B0) into where the twelve image frames have been removed. As a result, the frame selector 12 generates and transmits the image-frame sequence F6 shown in FIG. 6C.

According to the present embodiment, the image-frame sequence F6 transmitted has no empty frame space and has frames thereof arranged at constant intervals. Therefore, the data receiving side such as the high resolution processor can restore images from the image-frame sequence F6 even by using a conventional MPEG decoding circuit. In addition, since the inserted motionless frames of the transmitted image-frame sequence F6 have a small amount of data, the amount of data to be transmitted can be reduced.

### Third Embodiment

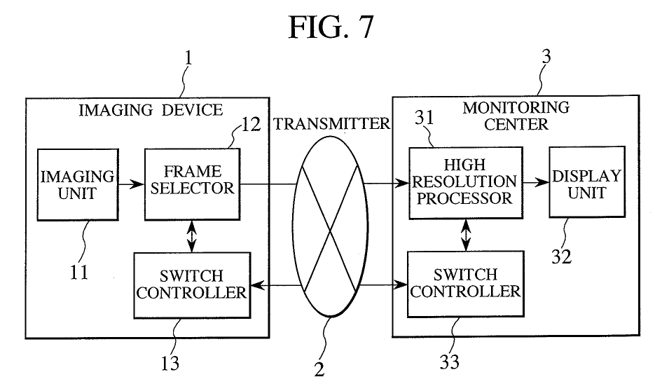

FIG. 7 is a diagram showing the configuration of a monitoring system according to a third embodiment of the present invention. The monitoring system according to the third embodiment is configured by adding a switch controller 13 to the imaging device 1 of the monitoring system according to the first embodiment and adding a switch controller 33 to the monitoring center 3 of the monitoring system according to the first embodiment. The switch controllers 13 and 33 are capable of communicating with each other through the transmitter 2.

The switch controller 13 included in the imaging device 1 is operable to switch on and off the frame removal processing to be performed by the frame selector 12. Also, the switch controller 13 sets conditions for the frame removal processing (the number N of successive image frames and the interval L at which groups of image frames remain after the frame removal processing). The switch controller 33 included in the monitoring center 3 switches on and off the high resolution processing to be performed by the high resolution processor 31. In addition, the switch controller 33 sets conditions for the high resolution processing (the number N of image frames to be used and the interval L at which image frames are processed). The switch controllers 13 and 33 inform each other of their own processing conditions through the transmitter 2. This configuration enables the coordination of those two types of processing so that each processing can be executed smoothly and optimally.

For example, when the number (N) of frames needs to be increased for a higher image resolution based on the state of an imaged subject displayed on the display unit 32 at the monitoring center 3 or when the intervals L between groups of successive image frames to be transmitted to the monitoring center 3 need to be shortened in order to produce seamless images of a moving subject, such requests can be sent to the imaging device 1. Furthermore, the monitoring system can be configured such that identical imaging devices are combined with multiple monitoring centers of different schemes.

According to each of the above-described embodiments, a monitoring system capable of displaying an acquired image at high quality and high resolution can be achieved as long as the amount of data to be transmitted is in an allowable range of transmission capability of the transmitter which uses a network or the like.

What is claimed is:

1. A monitoring system comprising:
an imaging device which acquires image data;
a transmitter which transmits the image data acquired by the imaging device; and
a monitoring center to which the image data is adapted to be transmitted through the transmitter, the monitoring center displaying an image based on the image data received from the transmitter;
wherein
the imaging device has a frame selector that performs frame removal processing for removing certain image frames from the image data such that groups of successive image frames remain at predetermined intervals; and
the monitoring center has a high resolution processor for performing high resolution processing with the use of received image frames.

2. The monitoring system according to claim 1, wherein
the frame selector has a motionless frame generator for generating motionless image frames indicating no motion compared with an image frame to be referenced, and the frame selector inserts the motionless image frames into positions in the image data at which image frames have been removed by the frame removal processing to form image data to be transmitted.

3. The monitoring system according to claim 1, wherein
the frame selector has an encoder for compressing the acquired image data in accordance with an MPEG scheme and performs the frame removal processing on the image data such that an I image frame that can be decoded independently is included in each of the groups of successive image frames.

4. The monitoring system according to claim 1, wherein
the high resolution processor aligns a group of successive image frames to generate a single image and performs re-sampling on the single image at an intended sampling rate to generate a high-resolution image.

5. The monitoring system according to claim 1, wherein
the imaging device has a first switch controller for controlling the frame removal processing to be performed by the frame selector;
the monitoring center has a second switch controller for controlling the high resolution processing to be performed by the high resolution processor; and
the first and second switch controllers inform each other of their own processing conditions through the transmitter.

6. An imaging device for transmitting acquired image data to a monitoring center, the imaging device comprising a frame selector that performs frame removal processing for removing certain image frames from the image data such that groups of successive image frames remain at predetermined intervals, wherein
the imaging device transmits image data obtained by the frame removal processing of the frame selector to the monitoring center.

7. The imaging device according to claim 6, wherein
the frame selector has a motionless frame generator that generates motionless image frames indicating no motion compared with an image frame to be referenced, and the frame selector inserts the motionless image frames into positions in the image data at which image frames have been removed by the frame removal processing to form image data to be transmitted.
